(19) United States
(12) Patent Application Publication
(10) Pub. No.: US 2004/0237794 A1
(43) Pub. Date: Dec. 2, 2004

(54) Holder for coffee pod

(75) Inventors: Frank Fulgoni, Sundern (DE); Hans-Josef Gerke, Sundern (DE); Siegfried Schnirch, Sundern (DE); Bernd Holz, Arnsberg (DE)

Correspondence Address: THE FIRM OF KARL F ROSS, 5676 RIVERDALE AVENUE, PO BOX 900, RIVERDALE (BRONX), NY, 10471-0900, US

(73) Assignee: SEVERIN ELEKTROGERATE GmbH

(21) Appl. No.: 10/845,788

(22) Filed: May 12, 2004

(30) Foreign Application Priority Data
May 13, 2003 (DE) 20307397.5
Sep. 30, 2003 (DE) 20315193.9

(51) Int. Cl. A47J 31/00

(52) U.S. Cl. 99/279

(57) ABSTRACT

A coffee holder has a cup shaped to hold a coffee pod and having a radially projecting rim and a floor and a collar projecting downward from the floor, forming a downwardly open outlet passage opening upward into the cup, and formed with at least one radially throughgoing hole. A nozzle fitted to the collar above the hole has a small-diameter aperture. The nozzle blocks the passage so that coffee flowing out of the cup through the passage must pass through the aperture and is aerated as it moves along the passage past the hole.

### FIELD OF THE INVENTION

The present invention relates to a holder for a coffee pod. More particularly this invention concerns the coffee-pod holder used in an espresso machine.

### BACKGROUND OF THE INVENTION

A portafilter or holder for a coffee pod, although of course it is usable with a filter and charge of loose coffee, comprises a cup typically having a handle and formed in its floor with an outlet port. The pod itself is normally made as a short cylindrical pad filled with ground coffee and having a flange forming a radial extension of its planar upper face. In use the pod is dropped into the cup of the portafilter, the portafilter is fitted to the group head, and hot water is forced down through the pod at a pressure of 1.5 bar to 2 bar, so that the desired infusion—coffee—drips from the outlet port into one or two cups sitting underneath it.

As described in NL 1,007,171 the holder cup is formed in its floor with an array of radially extending and upwardly open grooves that terminate at the central port. Thus the liquid exiting the bottom of the pod runs along these grooves to the port, whence it drips out of the holder.

A disadvantage of this system is that the coffee produced by it does not have the froth or crema that is made by a standard commercial or pressurized system using loose ground coffee that is tamped in the holder. The lack of such crema, which increases the aroma of the espresso thus produced, is considered a serious failing by coffee afficionados. In addition the holder is particularly hard to clean, especially once the grooves develop lime deposits.

A so-called perfect-crema disk is proposed for use in a coffee holder. It is a rubber disk with an aperture and serves mainly to increase back pressure on the grounds held in the pod. Such an accessory is largely ineffective in producing good crema, and is itself a bothersome item to deal with and maintain clean.

### OBJECTS OF THE INVENTION

It is therefore an object of the present invention to provide an improved pod holder for an espresso machine.

Another object is the provision of such an improved pod holder for an espresso machine which overcomes the above-given disadvantages, that is which produces a satisfactory crema even with coffee held in a pod or a filter paper, and that is easy to clean.

### SUMMARY OF THE INVENTION

A coffee holder has according to the invention a cup shaped to hold a coffee pod and having a radially projecting rim and a floor and a collar projecting downward from the floor, forming a downwardly open outlet passage opening upward into the cup, and formed with at least one radially throughgoing hole. A nozzle fitted to the collar above the hole has a small-diameter aperture. The nozzle blocks the passage so that coffee flowing out of the cup through the passage must pass through the aperture and is aerated as it moves along the passage past the hole.

Such a coffee holder can be used in a standard portafilter or can in fact be made part of the portafilter. It produces satisfactory crema even from a standard coffee pod or coffee held in a filter paper. As the coffee passes downward along the passage from the nozzle, it draws air inward through the hole or holes that are angled downward toward the center so that the entrained air forms the coffee into a crema the same as that formed by a standard tamped-coffee espresso machine.

The cup is formed with a radially projecting handle. In addition the nozzle is an insert fitted into an upper end of the passage and having a radially projecting rim seated in the floor at the upper end of the passage. Thus this nozzle can be exactly calibrated as to aperture size. The aperture has a diameter of at most 0.8 mm, normally 0.5 mm.

According to a further feature of the invention, a metal or plastic screen is provided on the floor overlying the nozzle, largely to prevent particles from clogging the nozzle's aperture. This screen is spaced upward from the nozzle and is of substantially greater diameter than the nozzle and/or the nozzle aperture so that even if it catches some particles there will be sufficient flow through it. Thus the coffee is aerated somewhat even before it passes through the nozzle. The floor is formed with a recess in which the screen is fitted and the cup and body are bodies of revolution centered on an axis of the passage.

### BRIEF DESCRIPTION OF THE DRAWING

The above and other objects, features, and advantages will become more readily apparent from the following description, reference being made to the accompanying drawing in which:

FIG. 1 is a top view of the holder according to the invention; and

FIG. 2 is a section taken along line II-II of FIG. 1.

### SPECIFIC DESCRIPTION

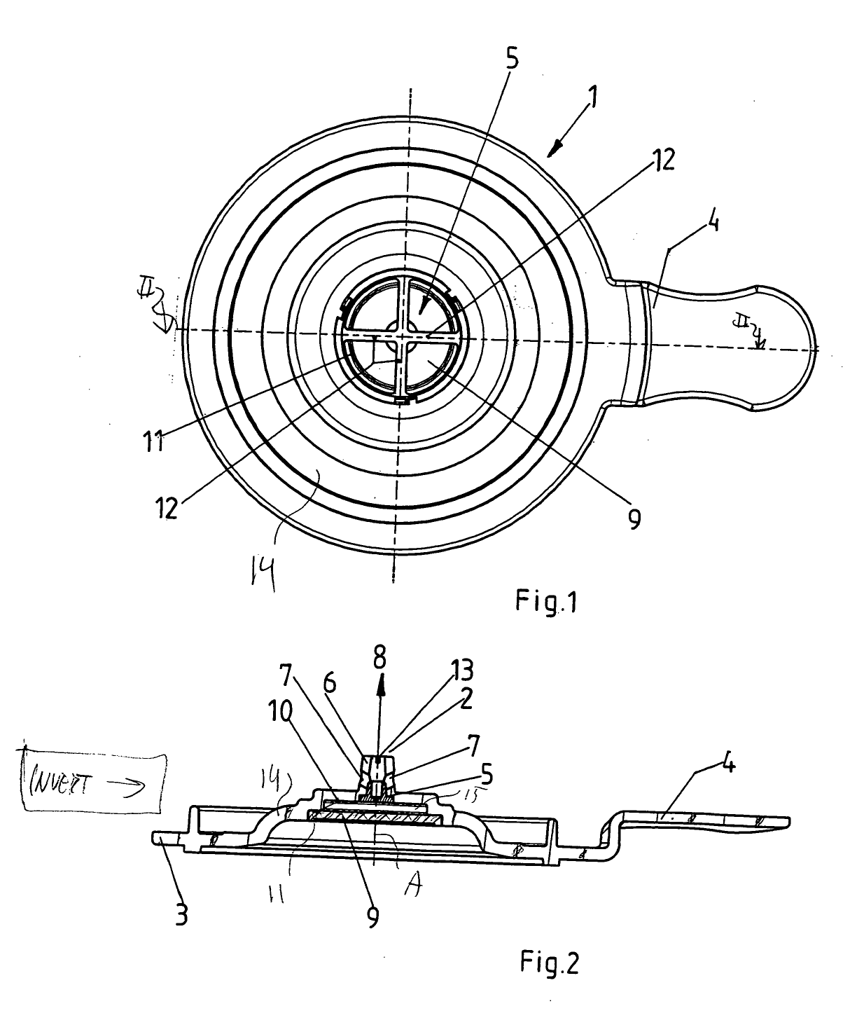

As seen in FIGS. 1 and 2, a holder 1 according to the invention is made of injection-molded plastic and basically comprises a cup 14 centered on an axis A, a planar flange 3 projecting radially from the cup 14, and a handle 4 in turn projecting radially from the flange 3. In use a standard coffee pod or a portion of ground coffee in a filter paper is set in the cup 14 and the holder 1 is set in turn in the portafilter, although of course the holder 1 itself could replace or be an integral part of the portafilter. Then water is forced at 1 bar to 2 bar down through the pod in the holder 1 to make coffee.

In accordance with the invention the cup part 14 of the holder 1 is formed centrally at the axis A with a downwardly extending collar 6 defining a downwardly open port or passage 8 and fitted with a stainless-steel nozzle 5 having a single circular-section throughgoing aperture 0.5 mm in diameter. Downstream or below the nozzle 5, the collar 6 is formed with laterally open holes 7 that aerate the infusion passing downward through the passage 8 to form the crema desired by coffee aficionados. This nozzle 5 is formed as a body of revolution set in the upper or upstream end of the collar 6 and passage 8 and having a flange or rim set flush in the floor of the cup 14.

The floor of the cup 14 is formed centered on the axis A with an upwardly open cylindrical recess 10 in which is set a screen 9 itself held in a plastic ring 11 having four radial spokes 12 meeting at the axis A. An unillustrated bayonet secures the entire subassembly 9, 11, 12 in the recess 11. The screen 9 can be a stainless-steel mesh and the ring 10 has a substantially larger diameter than the nozzle 10. It is spaced above the nozzle 5 by a short distance to form an empty space 15 so that the coffee passing through the screen 9 is preliminarily aerated even before it enters the nozzle 5.

In order to further aerate the coffee and form the best possible crema, the collar 6 is provided at its lower end with a diametrally throughgoing strut 13 that further breaks up the flow through the passage 8.

We claim:

1. A coffee holder comprising:
a cup shaped to hold a coffee pod and having a radially projecting rim and a floor;
a collar projecting downward from the floor, forming a downwardly open outlet passage opening upward into the cup, and formed with at least one radially throughgoing hole; and
a nozzle fitted to the collar above the hole and having a small-diameter aperture, the nozzle blocking the passage so that coffee flowing out of the cup through the passage must pass through the aperture, whereby the coffee is aerated as it moves along the passage past the hole.

2. The coffee holder defined in claim 1 wherein the cup is formed with a radially projecting handle.

3. The coffee holder defined in claim 1 wherein the nozzle is an insert fitted into an upper end of the passage.

4. The coffee holder defined in claim 3 wherein the nozzle has a radially projecting rim seated in the floor at the upper end of the passage.

5. The coffee holder defined in claim 1 wherein the aperture has a diameter of at most 0.8 mm.

6. The coffee holder defined in claim 1, further comprising
a screen on the floor overlying the nozzle.

7. The coffee holder defined in claim 6 wherein the screen is spaced upward from the nozzle.

8. The coffee holder defined in claim 6 wherein the floor is formed with a recess in which the screen is fitted.

9. The coffee holder defined in claim 1 wherein the cup and body are bodies of revolution centered on an axis of the passage.

10. The coffee holder defined in claim 1 wherein the collar is formed with a strut diametrally traversing the passage.
